(19) United States
(12) Patent Application Publication
(10) Pub. No.: US 2016/0160885 A1
(43) Pub. Date: Jun. 9, 2016

(54) HYDRAULIC CIRCUIT FOR AN ACTUATOR

(71) Applicant: KUBOTA CORPORATION, Osaka (JP)

(72) Inventors: Yoshiro TAKAO, Osaka (JP); Haruka KITAHARA, Osaka (JP)

(73) Assignee: KUBOTA CORPORATION, Osaka (JP)

(21) Appl. No.: 14/846,081

(22) Filed: Sep. 4, 2015

(30) Foreign Application Priority Data
Dec. 3, 2014 (JP) 2014-244768

(51) Int. Cl. F15B 13/02; F16K 1/44

(52) U.S. Cl. CPC F15B 13/021; F16K 1/44

(57) ABSTRACT

A hydraulic circuit includes a first oil passage communicating with a first port of an actuator and a second oil passage communicating with a second port of the actuator. A lower portion-communicating oil passage or oil discharge passage communicates with an oil tank. A first valve is provided between the first oil passage and the lower portion-communicating oil passage or oil discharge passage. The first valve is capable of allowing the first oil passage to communicate with the lower portion-communicating oil passage or the oil discharge passage when a pressure of the first oil passage reaches a predetermined value or higher. A second valve is located in a vicinity of the first valve and between the second oil passage and the lower portion-communicating oil passage or the oil discharge passage.

### CROSS-REFERENCE TO RELATED APPLICATIONS

The present application claims priority under 35 U.S.C. §119 of Japanese Application No. 2014-244768, filed on Dec. 3, 2014, the disclosure of which is expressly incorporated by reference herein in its entirety.

### BACKGROUND OF THE INVENTION

1. Field of the Invention

The present invention relates to a technology of a hydraulic circuit which controls operation of an actuator. The actuator and circuit can be arranged on a work vehicle.

2. Description of Related Art

Conventionally, technology relating to a hydraulic circuit which controls operation of an actuator is known, such as disclosed in Japanese Patent Publication No. 2765718.

Japanese Patent Publication No. 2765718 discloses a hydraulic circuit including a switching valve to appropriately supply hydraulic oil being pressure-fed from a hydraulic pump to a first port and a second port of the actuator. Additionally, a first valve (overload relief valve) and a second valve (makeup valve) are provided to each oil passage communicating with the first and second ports of the actuator, respectively. The first valve communicates with the second valve via a predetermined oil passage.

In the above described hydraulic circuit, when the pressure in a first oil passage increases substantially, such as due to a large load being imposed on the actuator, the first valve provided to the first oil passage is activated and discharges the hydraulic oil into the second oil passage. This prevents damage to the hydraulic circuit.

Further, normally, when high pressure occurs in the first oil passage, the pressure in a second oil passage decreases substantially. In such a case, the second valve provided to the second oil passage is activated and introduces the hydraulic oil in the first oil passage into the second oil passage. This suppresses the occurrence of cavitation.

As described above, the technology disclosed in Japanese Patent Publication No. 2765718 prevents damage to the hydraulic circuit and suppresses the occurrence of cavitation by appropriately moving the hydraulic oil between the first and second oil passages using the first and second valves.

In the above described technology, the occurrence of cavitation can be effectively suppressed by quickly introducing the hydraulic oil discharged from the first valve into the second valve. Thus, a technology in which hydraulic oil can be quickly supplied from the first valve to the second valve is desired.

### SUMMARY OF THE INVENTION

In view of the above circumstances, the present invention provides a hydraulic circuit in which hydraulic oil can be quickly supplied from a first valve to a second valve.

According to one aspect of the embodiment, a hydraulic circuit includes: a first oil passage communicating with a first port of an actuator; a second oil passage communicating with a second port of the actuator; an oil-discharging passage communicating with an oil tank; a first valve provided between the first oil passage and the oil-discharging passage, which discharges hydraulic oil in the first oil passage into the oil-discharging passage by causing the first oil passage to communicate with the oil-discharging passage when a pressure of the first oil passage reaches a predetermined value or higher; and a second valve provided in a vicinity of the first valve and between the second oil passage and the discharge passage, the second valve introducing hydraulic oil in the oil-discharging passage into the second oil passage by causing the second oil passage to communicate with the oil-discharging passage when a pressure of the second oil passage drops to a predetermined value or lower.

According to another aspect of the embodiment, the second valve is provided such that a distance between the second valve and the first valve is shorter than a distance between the first oil passage and the second oil passage.

According to another aspect of the embodiment, the first valve includes: a first communicating portion communicating with the first oil passage and the oil-discharging passage, and a first spool opening and closing the first communicating portion by sliding in a predetermined direction; and the second valve includes: a second communicating portion communicating with the second oil passage and the oil-discharging passage, and a second spool opening and closing the second communicating portion by sliding in a predetermined direction, the second spool being slidably provided on a same axis as the first spool.

According to another aspect of the embodiment, the second valve is positioned so that the second communicating portion opposes the first communicating portion.

According to another aspect of the embodiment, the second valve discharges hydraulic oil in the second oil passage into the oil-discharging passage by causing the second oil passage to communicate with the oil-discharging passage when the pressure of the second oil passage reaches a predetermined value or higher, and the first valve introduces hydraulic oil in the oil-discharging passage into the first oil passage by causing the first oil passage to communicate with the oil-discharging passage when the pressure of the first oil passage drops to a predetermined value or lower.

The effects exhibited by the present invention include the following.

According to one aspect of the embodiment, hydraulic oil can be quickly supplied from the first valve to the second valve. Thereby, the pressure in the second oil passage can be increased quickly, which consequently effectively suppresses the occurrence of cavitation in the second oil passage.

According to another aspect of the embodiment, hydraulic oil can be quickly supplied from the first valve to the second valve. Thus, a flow route of the hydraulic oil being supplied from the first valve to the second valve can be made shorter, thereby enabling quick supply of the hydraulic oil to the second valve.

According to another aspect of the embodiment, hydraulic oil can be quickly supplied from the first valve to the second valve. In other words, arranging the first spool of the first valve and the second spool of the second valve on the same axis enables linear flow of the hydraulic oil, thereby enabling quick supply of the hydraulic oil to the second valve. In addition, the configuration of the hydraulic circuit can be simplified, thereby reducing processing steps and the number of components.

According to another aspect of the embodiment, hydraulic oil can be quickly supplied from the first valve to the second valve. In other words, by aligning the flow direction of the hydraulic oil discharged from the first valve (direction of the opening of the first communicating portion) and the flow direction of the hydraulic oil discharged from the second valve (direction of the opening of the second communicating portion), the hydraulic oil can be quickly supplied to the second valve.

According to another aspect of the embodiment, excessive increase and decrease of pressure in the first oil passage and the second oil passage can be prevented by using the first valve and the second valve. In addition, by using the first and the second valves which also serve to prevent excessive increase and decrease of pressure, the number of valves may be reduced, and the configuration of the hydraulic circuit can be simplified and made smaller.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a front cross-sectional view of an overall configuration of a hydraulic circuit according to an embodiment of the present invention;

FIG. 2A is a front cross-sectional view of a first pressure control valve and FIG. 2B is a cross-sectional view taken along line A-A shown in FIG. 2B;

FIG. 3 is a front cross-sectional view of the first pressure control valve and a second pressure control valve in a normal state;

FIG. 4 is a front cross-sectional view of the first pressure control valve in a high pressure state;

FIG. 5 is a front cross-sectional view of the first pressure control valve in a low pressure state;

FIG. 6 is a front cross-sectional view of the first pressure control valve and the second pressure control valve when a pressure of a first oil passage increases;

FIG. 7 is a front cross-sectional view of the first pressure control valve and the second pressure control valve when a pressure of a second oil passage increases;

FIG. 8 is a front cross-sectional view of the first pressure control valve and the second pressure control valve according to a modification; and

FIG. 9 is front cross-sectional view of the first pressure control valve and the second pressure control valve according to the modification when the pressure of the first oil passage increases.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

In the description below, directions indicated by an arrow U, an arrow D, an arrow L, and an arrow R in the drawings shall be defined as an upward direction, a downward direction, a left direction, and a right direction, respectively.

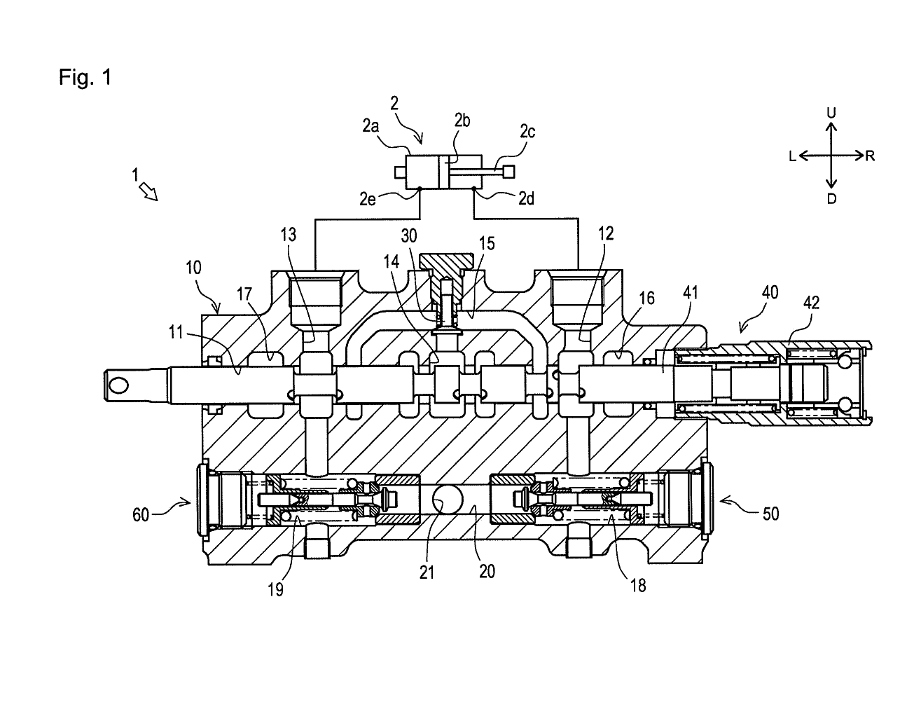

First, a configuration of a hydraulic circuit 1 according to one embodiment of the present invention is described with reference to FIG. 1.

The purpose of the hydraulic circuit 1 is to control operation of an actuator 2. The actuator 2 according to an embodiment of the present invention is a hydraulic cylinder including a cylinder tube 2a, a piston 2b being slidable within the cylinder tube 2a, and a piston rod 2c coupled to the piston 2b and projecting out of the cylinder tube 2a. When hydraulic oil is introduced through a first port 2d formed in an oil chamber on a head-side (side on which the piston rod 2c projects out of the cylinder tube 2a) of the cylinder tube 2a, the piston rod 2c contracts (slides leftward). On the other hand, when hydraulic oil is introduced through a second port 2e formed in an oil chamber on a cap-side (side opposite from the side on which the piston rod 2c projects out of the cylinder tube 2a) of the cylinder tube 2a, the piston rod 2c expands (slides rightward). The actuator 2 is used for various apparatuses (for example, a work apparatus such as a front loader or a backhoe).

The hydraulic circuit 1 primarily includes a housing 10, a check valve 30, a switching valve 40, a first pressure control valve 50, and a second pressure control valve 60.

The housing 10 can be formed in a substantially rectangular parallelepiped box shape. The housing 10 primarily includes a through hole 11, a first oil passage 12, a second oil passage 13, a pump-communicating oil passage 14, an oil-supplying passage 15, a first tank-communicating oil passage 16, a second tank-communicating oil passage 17, a first housing hole 18, a second housing hole 19, a lower portion-communicating oil passage 20, and a third tank-communicating oil passage 21.

The through hole 11 is a hole formed so as to cause a left side surface of the housing 10 to communicate with a right side surface of the housing 10. The through hole 11 is formed on an upper portion of the housing 10. The through hole 11 is formed on a straight line parallel to the left/right direction. The through hole 11 is formed so as to have a round-shaped cross-section as viewed from the side.

The first oil passage 12 communicates with the first port 2d of the actuator 2. The first oil passage 12 is formed on a right portion of the housing 10. The first oil passage 12 is formed on a straight line parallel to the up/down direction. The first oil passage 12 is formed so as to cause a top surface of the housing 10 to communicate with a bottom surface of the housing 10. A bottom end of the first oil passage 12 is closed as necessary. A top end of the first oil passage 12 communicates with the first port 2d of the actuator 2 via a piping and the like not shown in the drawings.

The second oil passage 13 communicates with the second port 2e of the actuator 2. The second oil passage 13 is formed on a left portion of the housing 10. The second oil passage 13 is formed on a straight line parallel to the up/down direction. Thus, the second oil passage 13 is formed in parallel with the first oil passage 12. The second oil passage 13 is formed so as to cause the top surface of the housing 10 to communicate with the bottom surface of the housing 10. A bottom end of the second oil passage 13 is closed as necessary. A top end of the second oil passage 13 communicates with the second port 2e of the actuator 2 via a piping and the like not shown in the drawings.

The pump-communicating oil passage 14 communicates with an oil pump not shown in the drawings. The pump-communicating oil passage 14 communicates with a substantially center portion in the left-right direction of the through hole 11. Hydraulic oil being pressure-fed from the oil pump is supplied to the pump-communicating oil passage 14.

The oil-supplying passage 15 supplies the hydraulic oil supplied via the pump-communicating oil passage 14 by causing the hydraulic oil to branch leftward and rightward. One end of the oil-supplying passage 15 communicates with the pump-communicating oil passage 14. A middle portion of the oil-supplying passage 15 is branched leftward and rightward. Left/right ends of the oil-supplying passage 15 each communicate with the through hole 11. More specifically, the right end of the oil-supplying passage 15 communicates with a portion of the through hole 11 positioned in-between the first oil passage 12 and the pump-communicating oil passage 14. The left end of the oil-supplying passage 15 communicates with a portion of the through hole 11 positioned in-between the second oil passage 13 and the pump-communicating oil passage 14.

The first tank-communicating oil passage 16 communicates with an oil tank not shown in the drawings. The first tank-communicating oil passage 16 communicates with an area in a vicinity of a right end of the through hole 11 (portion further rightward of the first oil passage 12).

The second tank-communicating oil passage 17 communicates with the oil tank. The second tank-communicating oil passage 17 communicates with an area in a vicinity of a left end of the through hole 11 (portion further leftward of the second oil passage 13).

The first housing hole 18 is a portion which houses the first pressure control valve 50 described below. The first housing hole 18 is formed on a lower right portion of the housing 10. The first housing hole 18 is formed in a straight line parallel to the left/right direction. The first housing hole 18 is formed in a predetermined length extending leftward from a right side surface of the housing 10 (and extends to an area in a vicinity of a center of the housing 10 in the left/right direction). The first housing hole 18 is formed so as to have a round-shaped cross-section as viewed from the side. A middle portion of the first housing hole 18 in the left/right direction communicates with an area in a vicinity of the bottom end of the first oil passage 12.

The second housing hole 19 is a portion which houses the second pressure control valve 60 described below. The second housing hole 19 is formed on a lower left portion of the housing 10. The second housing hole 19 is formed in a straight line parallel to the left/right direction. The second housing hole 19 is formed in a predetermined length from a left side surface of the housing 10 extending toward the right (and extends to the area in the vicinity of the center of the housing 10 in the left/right direction). The second housing hole 19 is formed so as to have a round-shaped cross-section as viewed from the side. An inner diameter of the second housing hole 19 is formed so as to be the same as an inner diameter of the first housing hole 18. A middle portion of the second housing hole 19 in the left/right direction communicates with an area in a vicinity of the bottom end of the second oil passage 13. The second housing hole 19 is formed so as to be positioned on the same axis as the first housing hole 18. A right end of the second housing hole 19 is spaced from a left end of the first housing hole 18 at a predetermined distance.

The lower portion-communicating oil passage 20 causes the first housing hole 18 to communicate with the second housing hole 19. The lower portion-communicating oil passage 20 is formed on a lower center portion of the housing 10 in the left/right direction. The lower portion-communicating oil passage 20 is formed on a straight line parallel to the left/right direction. The lower portion-communicating oil passage 20 is formed so as to cause the left end of the first housing hole 18 to communicate with the right end of the second housing hole 19. The lower portion-communicating oil passage 20 is formed so as to have a round-shaped cross-section as viewed from the side. An inner diameter of the lower portion-communicating oil passage 20 is formed so as to be smaller than the inner diameters of the first and second housing holes 18 and 19.

The third tank-communicating oil passage 21 communicates with the oil tank. The third tank-communicating oil passage 21 communicates with a middle portion of the lower portion-communicating oil passage 20 in the left/right direction. Specifically, the third tank-communicating oil passage 21 communicates with an area in a vicinity of a center of the lower portion-communicating oil passage 20 in the left/right direction that is slightly closer to the second housing hole 19.

The check valve 30 prevents backflow of hydraulic oil flowing through the oil-supplying passage 15. The check valve 30 is provided to the middle portion of the oil-supplying passage 15 (portion at which the oil-supplying passage 15 branches leftward and rightward). By providing the check valve 30, the hydraulic oil inside the oil-supplying passage 15 can be prevented from backflowing toward the pump-communicating oil passage 14.

The switching valve 40 switches a flow direction of hydraulic oil. The switching valve 40 primarily includes a spool 41 and a valve body 42.

The spool 41 is a substantially cylindrical member. The spool 41 is provided leftward and rightward in an axial direction (longitudinal direction). An outer diameter of the spool 41 is formed so as to be substantially the same as an inner diameter of the through hole 11. Grooves to guide hydraulic oil are appropriately formed on the spool 41 by cutting out an outer periphery of the spool 41. The spool 41 is inserted through the through hole 11. Left/right ends of the spool 41 project from the left/right side surfaces of the housing 10, respectively. The left end of the spool 41 communicates with an operator not shown in the drawings. By operating the operator, the spool 41 can slide leftward and rightward.

The valve body 42 is a substantially tubular member. The valve body 42 houses the right end of the spool 41. The valve body 42 houses a spring to bias the valve body 42 in a predetermined direction, a detent mechanism to hold the spool 41 in a predetermined position (position in the left/right direction), and the like. The valve body 42 is attached to the right side surface of the housing 10 (the right end portion of the through hole 11).

The first pressure control valve 50 controls the pressure in the first oil passage 12. More specifically, the first pressure control valve 50 prevents the pressure in the first oil passage 12 from increasing and decreasing excessively. The first pressure control valve 50 is housed in the first housing hole 18. A detailed configuration of the first pressure control valve 50 is provided below.

The second pressure control valve 60 controls the pressure in the second oil passage 13. More specifically, the second pressure control valve 60 prevents the pressure in the second oil passage 13 from increasing and decreasing excessively. The second pressure control valve 60 is housed in the second housing hole 19. A detailed configuration of the second pressure control valve 60 is provided below.

Next, a manner in which operation of the actuator 2 is controlled using the hydraulic circuit 1 configured as described above is described.

In the hydraulic circuit 1, the actuator 2 can be caused to contract by sliding the spool 41 of the switching valve 40 leftward or rightward as appropriate. A detailed explanation is set forth below.

In a state shown in FIG. 1, communication between the oil-supplying passage 15 and the first and second oil passages 12 and 13 is blocked by the spool 41. Hereafter, such position of the spool 41 will be referred to as the “neutral position.” In this state, the actuator 2 is held in place without contracting.

When the spool 41 slides leftward from the neutral position, the oil-supplying passage 15 communicates with the first oil passage 12 via the through hole 11. Thereby, hydraulic oil from the pump-communicating oil passage 14 is supplied to the first port 2d of the actuator 2 via the oil-supplying passage 15, the through hole 11, and the first oil passage 12. The hydraulic oil causes the piston 2b and the piston rod 2c to slide leftward with respect to the cylinder tube 2a, thereby causing the actuator 2 to contract.

Under this circumstance, the second oil passage 13 communicates with the second tank-communicating oil passage 17 via the through hole 11. Thereby, hydraulic oil from the second port 2e of the actuator 2 (hydraulic oil pushed out by the piston 2b) is supplied to the second tank-communicating oil passage 17 via the second oil passage 13 and the through hole 11. The hydraulic oil is discharged into the oil tank via the second tank-communicating oil passage 17.

When the spool 41 slides rightward from the neutral position, the oil-supplying passage 15 communicates with the second oil passage 13 via the through hole 11. Thereby, hydraulic oil from the pump-communicating oil passage 14 is supplied to the second port 2e of the actuator 2 via the oil-supplying passage 15, the through hole 11, and the second oil passage 13. The hydraulic oil causes the piston 2b and the piston rod 2c to slide rightward with respect to the cylinder tube 2a, thereby causing the actuator 2 to expand.

Under this circumstance, the first oil passage 12 communicates with the first tank-communicating oil passage 16 via the through hole 11. Thereby, hydraulic oil from the first port 2d of the actuator 2 (hydraulic oil pushed out by the piston 2b) is supplied to the first tank-communicating oil passage 16 via the first oil passage 12 and the through hole 11. The hydraulic oil is discharged into the oil tank via the first tank-communicating oil passage 16.

Next, detailed configurations of the first pressure control valve 50 and the second pressure control valve 60 are described. It is noted that the configuration of the second pressure control valve 60 is substantially the same as (laterally symmetrical to) the configuration of the first pressure control valve 50. Thus, hereafter, each member of the second pressure control valve 60 is assigned with the same symbol as a corresponding member of the first pressure control valve 50 and a detailed description of the configuration of the second pressure control valve 60 is omitted.

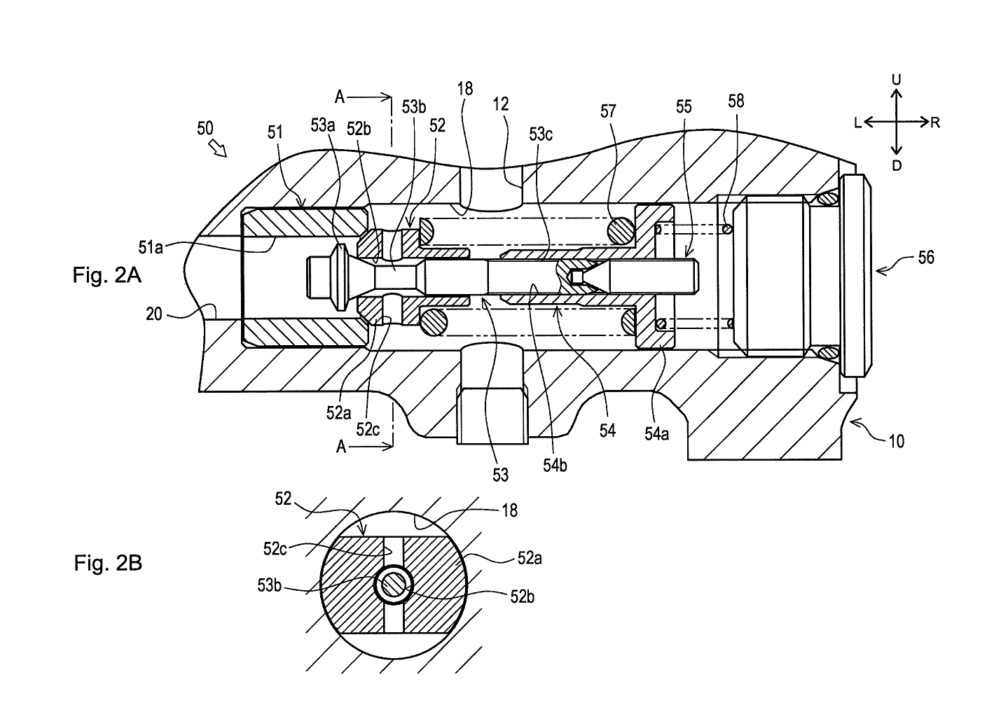

The first pressure control valve 50 illustrated in FIG. 2 (FIGS. 2A and 2B) primarily includes a valve seat 51, an outside spool 52, an inside spool 53, a spring receiver 54, a fixating screw 55, a closing member 56, a first spring 57, and a second spring 58.

The valve seat 51 is a substantially tubular member. The valve seat 51 is provided or oriented leftward and rightward in the axial direction. An outer diameter of the valve seat 51 is formed so as to be substantially the same as the inner diameter of the first housing hole 18. A through hole 51a is formed on the valve seat 51.

The through hole 51a is a hole formed so as to penetrate the valve seat 51 laterally. The through hole 51a is formed on the same axis as the valve seat 51. An inner diameter of the through hole 51a is formed so as to be substantially the same as the inner diameter of the lower portion-communicating oil passage 20.

The valve seat 51 having the above described configuration is housed in the left end portion (more precisely, leftward of the first oil passage 12) of the first housing hole 18. Thereby, a left end portion of the through hole 51a of the valve seat 51 is positioned so as to open toward the lower portion-communicating oil passage 20.

The outside spool 52 is a substantially cylindrical member. The outside spool 52 is provided or oriented leftward and rightward in the axial direction. An enlarged diameter portion 52a, a through hole 52b, and a communicating hole 52c are formed on the outside spool 52.

The enlarged diameter portion 52a is a portion shaped such that the diameter of the enlarged diameter portion 52a increases in a radial direction. The enlarged diameter portion 52a is formed on a left portion of the outside spool 52. An outer diameter of the enlarged diameter portion 52a is formed so as to be substantially the same as the inner diameter of the first housing hole 18. An end surface parallel to a horizontal direction is formed on a top end portion and a bottom end portion of the enlarged diameter portion 52a (see FIG. 2B). Thereby, a clearance is formed above and below the enlarged diameter portion 52a. A width of the enlarged diameter portion 52a in the up/down direction is formed so as to be larger than the inner diameter of the through hole 51a of the valve seat 51.

The through hole 52b is a hole formed so as to penetrate the outside spool 52 laterally. The through hole 52b is formed on the same axis as the outside spool 52.

The communicating hole 52c is a hole formed so as to penetrate the through hole 51a vertically. A center portion of the through hole 52b in the up/down direction communicates with the through hole 52b.

The outside spool 52 having the above described configuration is provided immediately rightward of the valve seat 51. Thereby, a left end portion of the through hole 52b of the outside spool 52 is positioned so as to open toward the through hole 51a of the valve seat 51 (and therefore the lower portion-communicating oil passage 20). Under this circumstance, the enlarged diameter portion 52a is slidably abutted on the first housing hole 18. Thus, the outside spool 52 can slide leftward and rightward in the first housing hole 18.

An inside spool 53 is a substantially cylindrical member. The inside spool 53 is provided leftward and rightward in the axial direction. An enlarged diameter portion 53a, a reduced diameter portion 53b, and a male screw 53c are formed on the inside spool 53.

The enlarged diameter portion 53a is a portion shaped such that the diameter of the enlarged diameter portion 53a increases in the radial direction. The enlarged diameter portion 53a is formed in a vicinity of the left end portion of the inside spool 53. An outer diameter of the enlarged diameter portion 53a is formed so as to be larger than an inner diameter of the through hole 52b of the outside spool 52 and smaller than the inner diameter of the through hole 51a of the valve seat 51.

The reduced diameter portion 53b is a portion shaped such that the diameter of the reduced diameter portion 53b decreases in the radial direction. The reduced diameter portion 53b is formed immediately rightward of the enlarged diameter portion 53a. An outer diameter of the reduced diameter portion 53b is formed so as to be smaller than the inner diameter of the through hole 52b of the outside spool 52.

The male screw 53c is a portion on which a screw or thread is formed on an outer peripheral surface of the male screw 53c. The male screw 53c is formed so as to extend from a center portion of the inside spool 53 in the left/right direction to the right end portion of the inside spool 53.

The inside spool 53 having the above described configuration is slidably inserted through the through hole 52b of the outside spool 52. Under this circumstance, the reduced diameter portion 53b of the inside spool 53 is positioned so as to be opposite the communicating hole 52c of the outside spool 52.

The spring receiver 54 is a substantially cylindrical member. The spring receiver 54 is provided or oriented leftward and rightward in the axial direction. An enlarged diameter portion 54a and a female screw hole 54b are formed on the spring receiver 54.

The enlarged diameter portion 54a is a portion shaped such that the diameter of the enlarged diameter portion 54a increases in the radial direction. The enlarged diameter portion 54a is formed in a vicinity of a right end portion of the spring receiver 54. An outer diameter of the enlarged diameter portion 54a is formed so as to be substantially the same as the inner diameter of the first housing hole 18.

The female screw hole 54b is a through hole on which a screw or thread is formed on an inner peripheral surface of the female screw 54b. The female screw hole 54b is formed so as to extend an entire area of a through hole formed on the spring receiver 54, the through hole formed so as to penetrate the spring receiver 54 laterally.

The spring receiver 54 having the above described configuration is housed in a middle portion of the first housing hole 18 in the left/right direction. Under this circumstance, the enlarged diameter portion 54a is slidably abutted on the first housing hole 18. In addition, the male screw 53c of the inside spool 53 is fastened to a left portion of the female screw hole 54b of the spring receiver 54. Thus, the spring receiver 54 can slide leftward and rightward in the first housing hole 18 integrally with the inside spool 53.

The fixating screw 55 is a substantially cylindrical member on which a screw or thread is formed on an outer peripheral surface of the fixating screw 55. The fixating screw 55 is fastened to a right portion of the female screw hole 54b of the spring receiver 54 and is also engaged with the inside spool 53. In this way, the fixating screw 55 securely connects the inside spool 53 and the spring receiver 54 so that the inside spool 53 and the spring receiver 54 do not become loose.

The closing member 56 is a substantially cylindrical member. The closing member 56 is fixated to the right end portion of the first housing hole 18 and closes the right end of the first housing hole 18.

The first spring 57 is a compression coil spring biasing the outside spool 52 and the spring receiver 54 away from each other. The first spring 57 is provided or oriented leftward and rightward in the axial direction so as to be expandable and contractible in the left/right direction. The first spring 57 is provided between the enlarged diameter portion 52a of the outside spool 52 and the enlarged diameter portion 54a of the spring receiver 54.

The second spring 58 is a compression coil spring biasing the spring receiver 54 and the closing member 56 away from each other (i.e., leftward). The second spring 58 is provided or oriented leftward and rightward in the axial direction so as to be expandable and contractible in the left/right direction. The second spring 58 is provided between the enlarged diameter portion 54a of the spring receiver 54 and the closing member 56.

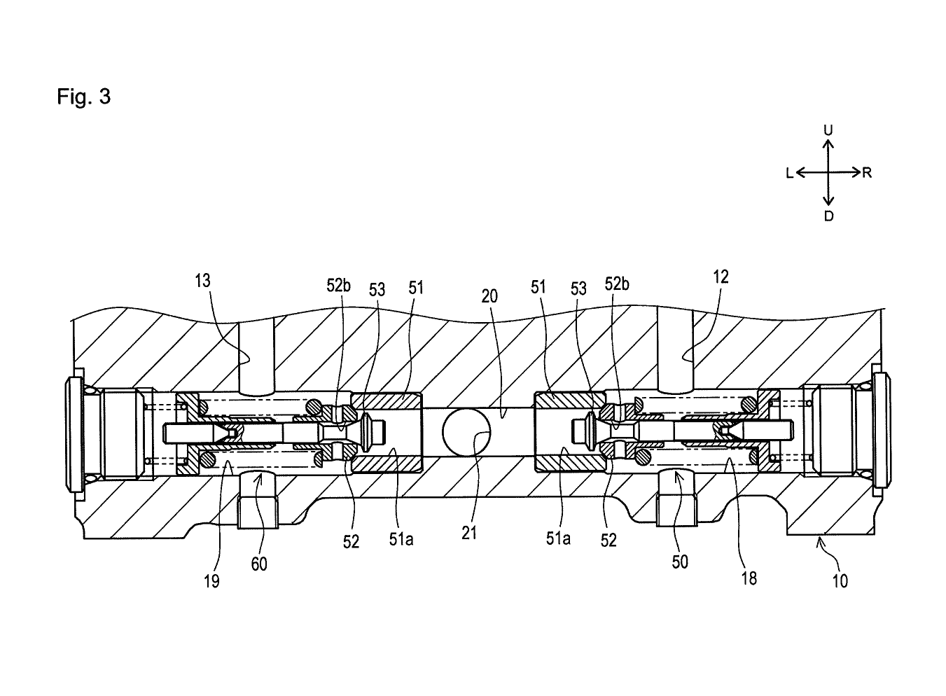

The second pressure control valve 60 is configured substantially in the same way as the above described first pressure control valve 50. Specifically, as illustrated in FIG. 3, the second pressure control valve 60 is configured laterally symmetrically to the first pressure control valve 50. The second pressure control valve 60 is housed in the second housing hole 19. Thus, the second pressure control valve 60 is positioned so as to face, and be on the same axis as, the first pressure control valve 50.

Under this circumstance, the through holes 51a and 52b of the second pressure control valve 60 are positioned so as to be opposite the through holes 51a and 52b of the first pressure control valve 50 with the lower portion-communicating oil passage 20 positioned therebetween. In addition, the second pressure control valve 60 is positioned so that a distance between a left end of the first pressure control valve 50 and a right end of the second pressure control valve 60 (distance along the left/right direction) is shorter than a distance between the first oil passage 12 and the second oil passage 13 (distance along the left/right direction). In this instance, the distance between the first oil passage 12 and the second oil passage 13 specifically means a distance from a point at which axes of the first oil passage 12 and the first pressure control valve 50 (the first housing hole 18) intersect to a point at which axes of the second oil passage 13 and the second pressure control valve 60 (the second housing hole 19) intersect. Further, the second pressure control valve 60 is positioned so that a width from the right end of the first pressure control valve 50 to the left end of the second pressure control valve 60 in the left/right direction is smaller than a width of the switching valve 40 (see FIG. 1) in the left/right direction. In this way, the first pressure control valve 50 and the second pressure control valve 60 are arranged in a vicinity of each other.

Next, operation of the first pressure control valve 50 having the above described configuration is described. Operation of the first pressure control valve 50 in each of the following cases is described below: a case in which the pressure in the first oil passage 12 does not increase or decrease substantially (hereinafter referred to simply as “normal state”); a case in which the pressure in the first oil passage 12 increases substantially (hereinafter referred to simply as “high pressure state”); and a case in which the pressure in the first oil passage 12 decreases substantially (hereinafter referred to simply as “low pressure state”).

As illustrated in FIG. 2, in the normal state, the spring receiver 54 slides away from the outside spool 52 (i.e., rightward with respect to the outside spool 52) by the biasing force of the first spring 57. The inside spool 53 also slides rightward with respect to the outside spool 52 along with the spring receiver 54. Thereby, the enlarged diameter portion 53a of the inside spool 53 abuts on the left end of the through hole 52b of the outside spool 52 and blocks the through hole 52b.

In addition, in the normal state, the spring receiver 54 slides leftward by the biasing force of the second spring 58. The outside spool 52 and the inside spool 53 also slides leftward with respect to the first housing hole 18 along with the spring receiver 54. Thereby, the enlarged diameter portion 52a of the outside spool 52 abuts on the right end of the through hole 51a and blocks the through hole 51a.

In this way, in the normal state, the through hole 51a of the valve seat 51 and the through hole 52b of the outside spool 52 are blocked. Thus, communication between the first oil passage 12 and the lower portion-communicating oil passage 20 is blocked. In this state, hydraulic oil does not flow between the first oil passage 12 and the lower portion-communicating oil passage 20.

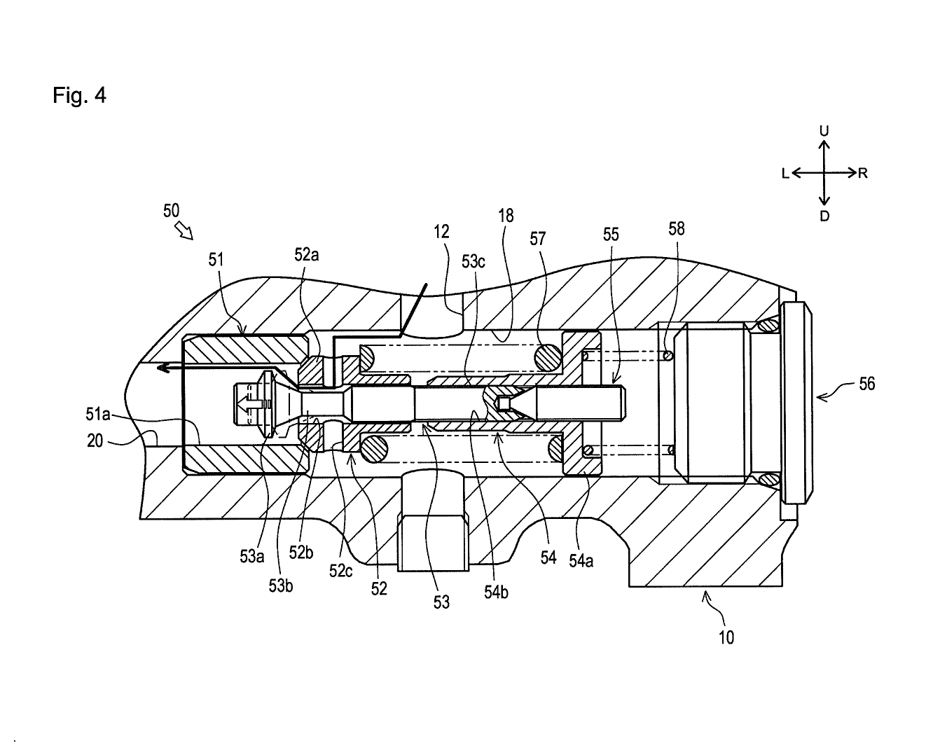

As illustrated in FIG. 4, in the high pressure state, the inside spool 53 is biased leftward by the pressure of the hydraulic oil in the first oil passage 12. When the pressure of the hydraulic oil in the first oil passage 12 reaches a predetermined value or higher, the inside spool 53 slides leftward against the biasing force of the first spring 57. When the inside spool 53 slides leftward, the enlarged diameter portion 53a of the inside spool 53 separates from the left end of the through hole 52b of the outside spool 52. Thereby, the first oil passage 12 communicates with the lower portion-communicating oil passage 20 via the first housing hole 18, the communicating hole 52c, the through hole 52b, and the through hole 51a.

In this way, in the high pressure state, the through hole 52b of the outside spool 52 is released and the first oil passage 12 communicates with the lower portion-communicating oil passage 20. In this state, high-pressure hydraulic oil in the first oil passage 12 is discharged into the lower portion-communicating oil passage 20 via the first housing hole 18 and the like. Thereby, the pressure in the first oil passage 12 can be decreased. Therefore, in such a case, the first pressure control valve 50 serves as an overload relief valve which prevents excessive increase of pressure in the first oil passage 12.

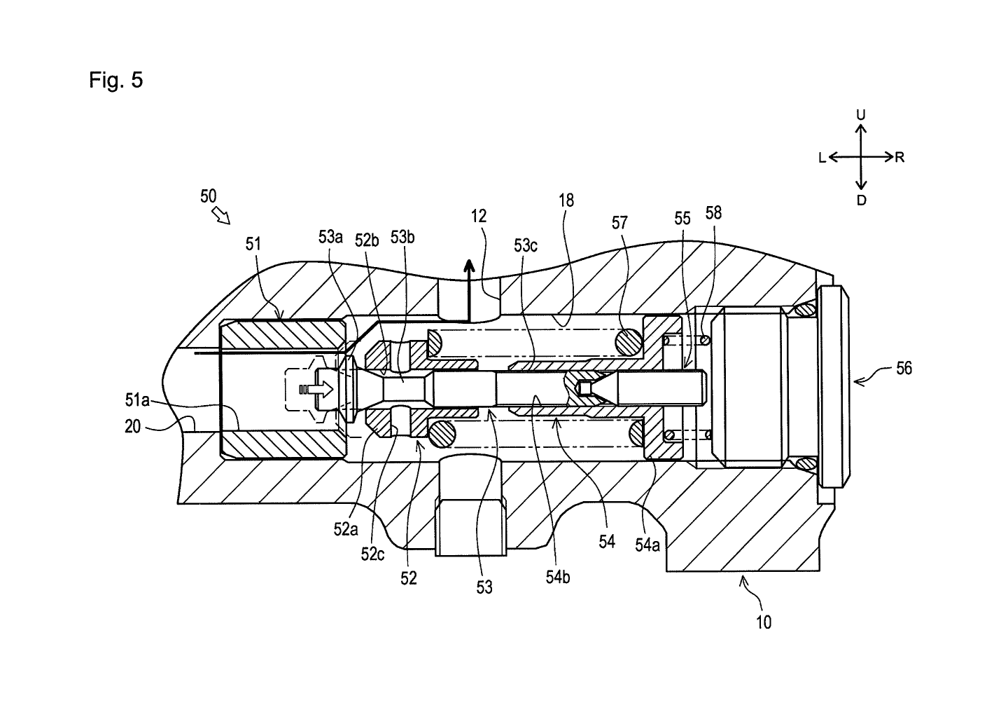

As illustrated in FIG. 5, in the low pressure state, the outside spool 52 is biased rightward by the pressure of the hydraulic oil in the lower portion-communicating oil passage 20. When the pressure of the hydraulic oil in the first oil passage 12 drops to a predetermined value or lower, the outside spool 52 slides rightward against the biasing force of the second spring 58. When the outside spool 52 slides rightward, the enlarged diameter portion 52a of the outside spool 52 separates from the right end of the through hole 51a of the valve seat 51. Thereby, the lower portion-communicating oil passage 20 communicates with the first oil passage 12 via the through hole 51a and the first housing hole 18.

In this way, in the low pressure state, the through hole 51a of the valve seat 51 is released and the lower portion-communicating oil passage 20 communicates with the first oil passage 12. In this state, hydraulic oil in the lower portion-communicating oil passage 20 having a higher pressure than the hydraulic oil in the first oil passage 12 is introduced into the first oil passage 12 via the first housing hole 18 and the like. Thereby, the pressure in the first oil passage 12 can be increased. Therefore, in such a case, the first pressure control valve 50 serves as an anti-cavitation valve which prevents cavitation by preventing excessive decrease of pressure in the first oil passage 12.

It is noted that the second pressure control valve 60 operates similarly to the first pressure control valve 50. In other words, in the normal state (i.e., a case in which the pressure in the second oil passage 13 does not increase or decrease substantially) the second pressure control valve 60 blocks communication between the second oil passage 13 and the lower portion-communicating oil passage 20.

In the high pressure state (i.e., a case in which the pressure in the second oil passage 13 increases substantially), the second pressure control valve 60 causes the second oil passage 13 to communicate with the lower portion-communicating oil passage 20. In this state, high-pressure hydraulic oil in the second oil passage 13 is discharged into the lower portion-communicating oil passage 20 via the second housing hole 19 and the like. Thereby, the pressure in the second oil passage 13 can be decreased.

In the low pressure state (i.e., a case in which the pressure in the second oil passage 13 decreases substantially), the second pressure control valve 60 causes the second oil passage 13 to communicate with the lower portion-communicating oil passage 20. In this state, hydraulic oil in the lower portion-communicating oil passage 20 having a higher pressure than the hydraulic oil in the second oil passage 13 is introduced into the second oil passage 13 via the second housing hole 19 and the like. Thereby, the pressure in the second oil passage 13 can be increased.

Next, a manner in which the first oil passage 12 and the second oil passage 13 are controlled in the hydraulic circuit 1 having the above described configuration is described in a case where pressures in the first oil passage 12 and the second oil passage 13 increase and decrease substantially.

When a large load is imposed on the actuator 2 in a state where the spool 41 of the switching valve 40 is in the neutral position (see FIG. 1), the pressure in the first oil passage 12 or the second oil passage 13 increases substantially. A manner in which the first oil passage 12 and the second oil passage 13 are controlled in each of the following cases is described below: a case in which the pressure in the first oil passage 12 increases substantially and a case in which the pressure in the second oil passage 13 increases substantially.

First, the case in which the pressure in the first oil passage 12 increases substantially is described. When a large load is imposed on the actuator 2 in the direction that the actuator 2 expands (direction in which the piston rod 2c slides rightward), the head-side oil chamber of the cylinder tube 2a is compressed. Thereby, the pressure in the first oil passage 12 increases via the first port 2d.

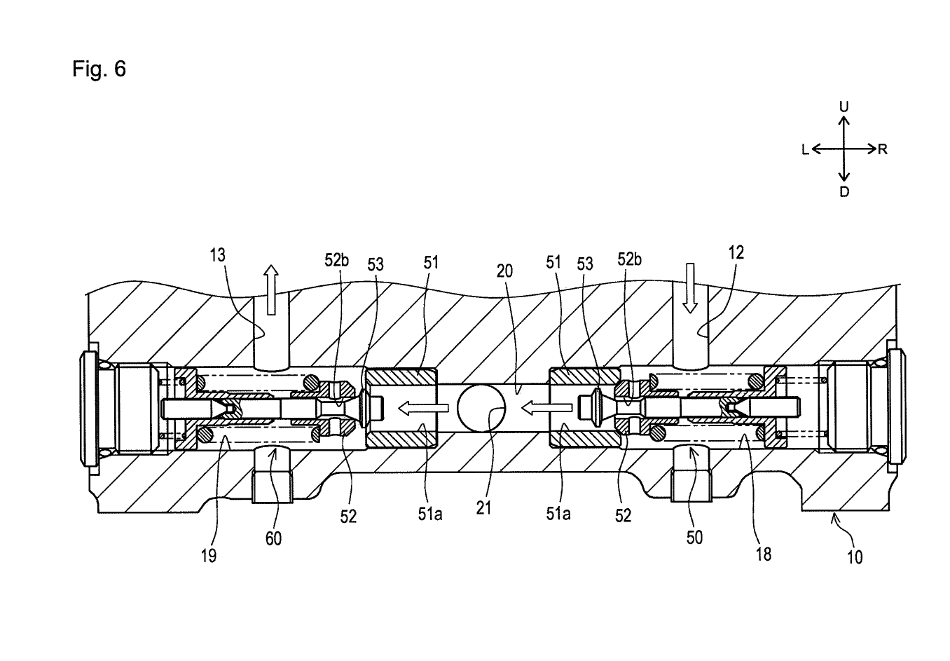

As illustrated in FIG. 6, in this case, the first pressure control valve 50 causes the lower portion-communicating oil passage 20 to communicate with the first oil passage 12. This causes the hydraulic oil in the first oil passage 12 to be discharged leftward (toward the lower portion-communicating oil passage 20) from the left end portion of the first pressure control valve 50, thereby decreasing the pressure in the first oil passage 12. Thus, malfunction caused by excessive increase of pressure in the first oil passage 12 (damage to the actuator 2 and the hydraulic circuit 1, for example) can be prevented.

Further, when a large load is imposed on the actuator 2 in the direction that the actuator 2 expands, the cap-side oil chamber of the cylinder tube 2a is expanded. Thereby, the pressure in the second oil passage 13 decreases via the second port 2e.

In this case, the second pressure control valve 60 causes the lower portion-communicating oil passage 20 to communicate with the second oil passage 13. This causes the hydraulic oil in the lower portion-communicating oil passage 20 (i.e., hydraulic oil discharged from the first oil passage 12) to be introduced into the second oil passage 13 via the second pressure control valve 60, thereby increasing the pressure in the second oil passage 13. Thus, cavitation caused by excessive decrease of pressure in the second oil passage 13 can be prevented.

Under this circumstance, the left end portion of the first pressure control valve 50 and the right end portion of the second pressure control valve 60 are arranged in the vicinity of each other. Specifically, the left end portion of the first pressure control valve 50 (the through hole 52b of the outside spool 52, in particular) and the right end portion of the second pressure control valve 60 (the through hole 51a of the valve seat 51, in particular) are positioned so as to face each other on a straight line with the lower portion-communicating oil passage 20 positioned therebetween. Thus, the hydraulic oil discharged from the first oil passage 12 via the first pressure control valve 50 is quickly guided to the second pressure control valve 60 and eventually introduced into the second oil passage 13. This enables effective suppression of cavitation in the second oil passage 13. It is noted that under this circumstance, unnecessary hydraulic oil is discharged from the lower portion-communicating oil passage 20 into the oil tank via the third tank-communicating oil passage 21.

Next, the case in which the pressure in the second oil passage 13 increases substantially is described. When a large load is imposed on the actuator 2 in the direction that the actuator 2 contracts (direction in which the piston rod 2c slides leftward), the cap-side oil chamber of the cylinder tube 2a is compressed. Thereby, the pressure in the second oil passage 13 increases via the second port 2e.

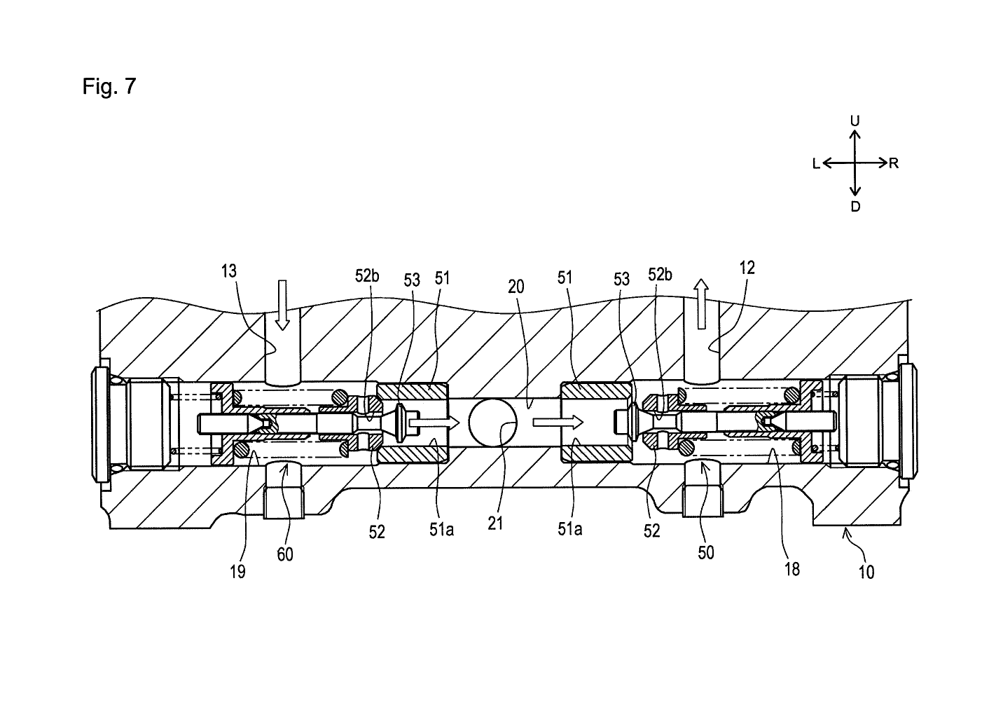

As illustrated in FIG. 7, in this case, the second pressure control valve 60 causes the lower portion-communicating oil passage 20 to communicate with the second oil passage 13. This causes the hydraulic oil in the second oil passage 13 to be discharged rightward (toward the lower portion-communicating oil passage 20) from the right end portion of the second pressure control valve 60, thereby decreasing the pressure in the second oil passage 13. Thus, malfunction caused by excessive increase of pressure in the second oil passage 13 (damage to the actuator 2 and the hydraulic circuit 1, for example) can be prevented.

Further, when a large load is imposed on the actuator 2 in the direction that the actuator 2 contracts, the head-side oil chamber of the cylinder tube 2a is expanded. Thereby, the pressure in the first oil passage 12 decreases via the first port 2d.

In this case, the first pressure control valve 50 causes the lower portion-communicating oil passage 20 to communicate with the first oil passage 12. This causes the hydraulic oil in the lower portion-communicating oil passage 20 (i.e., hydraulic oil discharged from the second oil passage 13) to be introduced into the first oil passage 12 via the first pressure control valve 50, thereby increasing the pressure in the first oil passage 12. Thus, cavitation caused by excessive decrease of pressure in the first oil passage 12 can be prevented.

Under this circumstance, the left end portion of the first pressure control valve 50 and the right end portion of the second pressure control valve 60 are arranged in the vicinity of each other. Specifically, the left end portion of the first pressure control valve 50 (the through hole 51a of the valve seat 51, in particular) and the right end portion of the second pressure control valve 60 (the through hole 52b of the outside spool 52, in particular) are positioned so as to face each other on a straight line with the lower portion-communicating oil passage 20 positioned therebetween. Thus, the hydraulic oil discharged from the second oil passage 13 via the second pressure control valve 60 is quickly guided to the first pressure control valve 50 and eventually introduced into the first oil passage 12. This enables effective suppression of cavitation in the first oil passage 12. It is noted that under this circumstance, unnecessary hydraulic oil is discharged from the lower portion-communicating oil passage 20 into the oil tank via the third tank-communicating oil passage 21.

As described above, the hydraulic circuit 1 according to the present embodiment can quickly supply hydraulic oil from the first pressure control valve 50 to the second pressure control valve 60. Thus, the pressure in the second oil passage 13 can be increased quickly, which consequently effectively suppresses the occurrence of cavitation in the second oil passage 13.

Additionally, in the present embodiment, a flow route of the hydraulic oil being supplied from the first pressure control valve 50 to the second pressure control valve 60 can be made shorter, thereby enabling quick supply of the hydraulic oil to the second pressure control valve 60.

Further, in the present embodiment, arranging the outside spool 52 of the second pressure control valve 60 and the inside spool 53 of the first pressure control valve 50 on the same axis enables linear flow of the hydraulic oil, thereby enabling quick supply of the hydraulic oil to the second pressure control valve 60. In addition, the configuration of the hydraulic circuit 1 can be simplified, which enables reduction of processing steps and number of components. In addition, by causing the third tank-communicating oil passage 21 to communicate with the outside spool 52 and the inside spool 53 on the same axis, a common oil passage (the third tank-communicating oil passage 21) can be used for discharging hydraulic oil into the oil tank.

In addition, in the present embodiment, by aligning the flow direction of the hydraulic oil discharged from the first pressure control valve 50 (direction of the opening of the through hole 52b) and the flow direction of the hydraulic oil discharged from the second pressure control valve 60 (direction of the opening of the through hole 51a), the hydraulic oil can be quickly supplied to the second pressure control valve 60. In addition, since the hydraulic oil which is discharged from the first pressure control valve 50 does not flow in a vicinity of other members (a sealing member to prevent hydraulic oil from leaking from the housing 10, for example), damage to other members caused by the pressure of the hydraulic oil can be prevented.

In addition, in the present embodiment, excessive increase and decrease of pressure in the first oil passage 12 and the second oil passage 13 can be prevented by using the first pressure control valve 50 and the second pressure control valve 60. In addition, by using the first pressure control valve 50 and the second pressure control valve 60 which also serve as the overload relief valve and the anti-cavitation valve, the number of valves may be reduced, and the configuration of the hydraulic circuit 1 can be simplified and made smaller.

It is noted that the first port 2d according to the present embodiment is one embodiment of a first port according to the present invention. Additionally, the first oil passage 12 according to the present embodiment is one embodiment of a first oil passage according to the present invention. Additionally, the second port 2e according to the present embodiment is one embodiment of second port according to the present invention. Additionally, the second oil passage 13 according to the present embodiment is one embodiment of a second oil passage according to the present invention. Additionally, the lower portion-communicating oil passage 20 according to the present embodiment is one embodiment of an oil-discharging passage according to the present invention. Additionally, the first pressure control valve 50 according to the present embodiment is one embodiment of a first valve according to the present invention. Additionally, the second pressure control valve 60 according to the present embodiment is one embodiment of a second valve according to the present invention. Additionally, the through hole 52b of the first pressure control valve 50 according to the present embodiment is one embodiment of a first communicating portion according to the present invention. Additionally, the inside spool 53 of the first pressure control valve 50 according to the present embodiment is one embodiment of a first spool according to the present invention. Additionally, the through hole 51a of the second pressure control valve 60 according to the present embodiment is one embodiment of a second communicating portion according to the present invention. Additionally, the outside spool 52 of the second pressure control valve 60 according to the present embodiment is one embodiment of a second spool according to the present invention.

The embodiment of the present invention is as described above; however, the present invention is not limited to the above configuration and various changes may be made within the scope of the invention disclosed in the claims.

For instance, in the present embodiment, a hydraulic cylinder is illustrated as the actuator 2; however, the present invention is not limited thereto and any hydraulically operated actuator (a hydraulic motor, for example) may be used.

In addition, in the present embodiment, the hydraulic circuit 1 controls operation of one actuator 2; however, the present invention is not limited thereto. In other words, the switching valve 40 may include a plurality of the switching valves 40, the first pressure control valves 50, the second pressure control valves 60 and the like to control operation of a plurality of actuators independently.

In addition, in the present embodiment, the first pressure control valve 50 and the second pressure control valve 60 are arranged on the same axis; however, the present invention is not limited thereto. In other words, provided that the first pressure control valve 50 and the second pressure control valve 60 are arranged in the vicinity of each other, the direction of the arrangement is not limited. For instance, a longitudinal direction of the first pressure control valve 50 may be arranged to face the left/right direction and a longitudinal direction of the second pressure control valve 60 may be arranged to face the up/down direction (i.e., arranging the first pressure control valve 50 and the second pressure control valve 60 in a substantially L-shape).

In addition, in the present embodiment, the first pressure control valve 50 and the second pressure control valve 60 serve as the overload relief valve and the anti-cavitation valve; however, the present invention is not limited thereto. For instance, a configuration in which the first pressure control valve 50 serves as the overload relief valve only and the second pressure control valve 60 serves as the anti-cavitation valve only is also possible. In such a case, it is preferable that each of the first oil passage 12 and the second oil passage 13 separately includes the anti-cavitation valve and the overload relief valve.

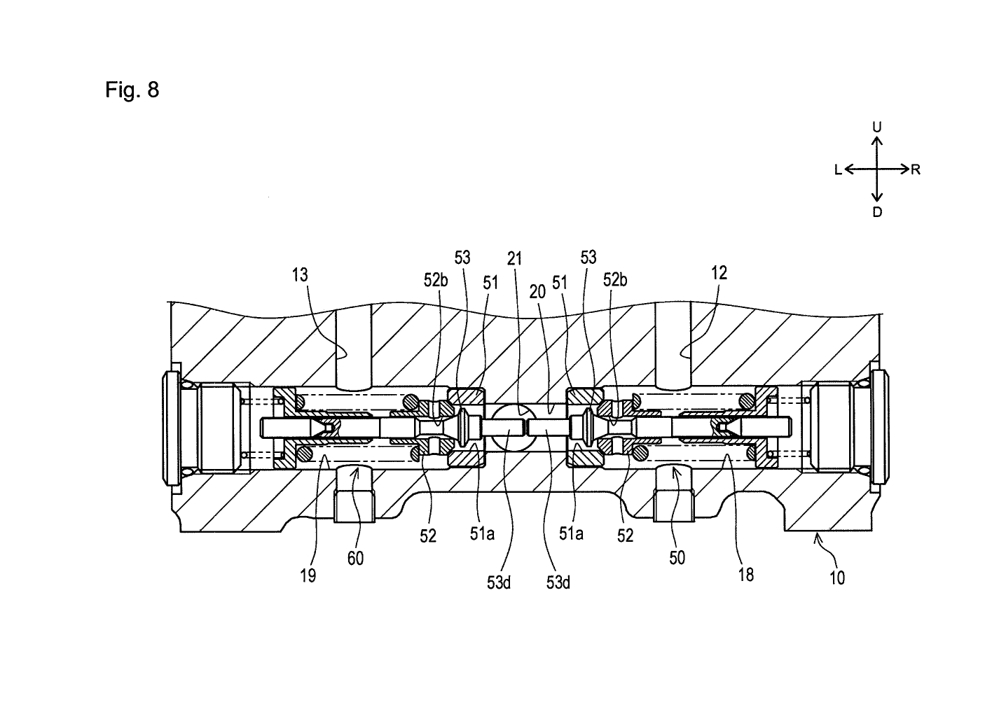

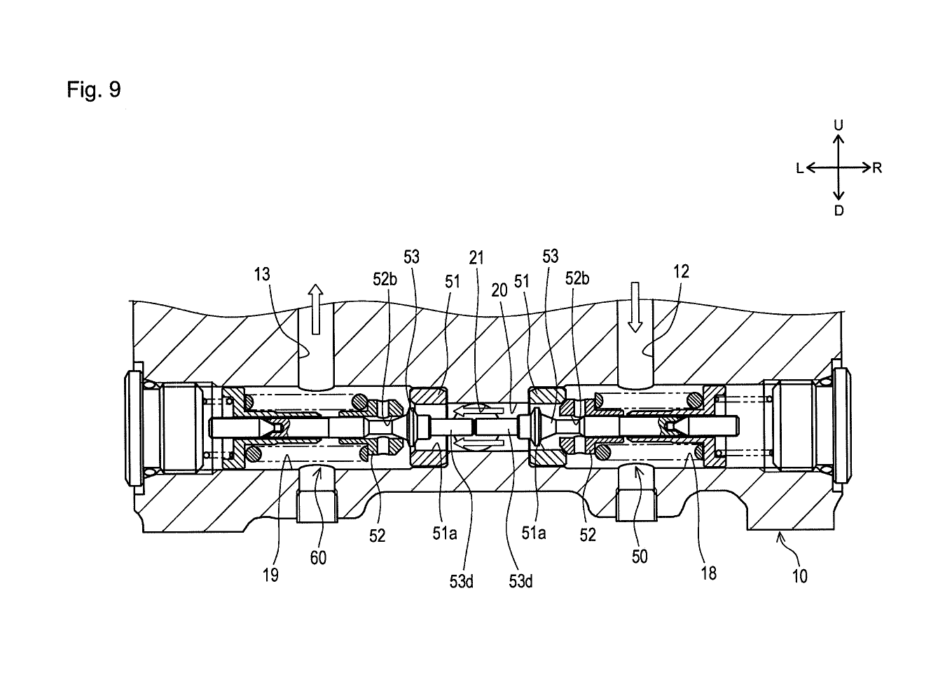

In addition, specific configurations of the first valve and the second valve according to the present invention are not limited to the configurations of the first pressure control valve 50 and the second pressure control valve 60 according to the present embodiment. For instance, a configuration of a modification as illustrated in FIGS. 8 and 9 is also possible.

FIG. 8 illustrates the modification of the first pressure control valve 50 and the second pressure control valve 60. An abutting portion 53d is formed on the first pressure control valve 50 according to the modification. The abutting portion 53d is a substantially cylindrical member formed so as to project leftward from the left end of the inside spool 53 of the first pressure control valve 50.

Similarly, an abutting portion 53d is also formed on the second pressure control valve 60 according to the modification. The abutting portion 53d is a substantially cylindrical member formed so as to project rightward from the right end of the inside spool 53 of the second pressure control valve 60. A front end (right end) of the abutting portion 53d of the second pressure control valve 60 is positioned so as to be in a vicinity of a front end (left end) of the abutting portion 53d of the first pressure control valve 50.

As illustrated in FIG. 9, when the pressure in the first oil passage 12 increases, the inside spool 53 of the first pressure control valve 50 slides leftward, thereby causing the lower portion-communicating oil passage 20 to communicate with the first oil passage 12. Under this circumstance, the abutting portion 53d of the first pressure control valve 50 contacts and presses the abutting portion 53d of the second pressure control valve 60 from the right side. Thus, the outside spool 52 of the second pressure control valve 60 is caused to slide leftward by the pressure of the hydraulic oil in the lower portion-communicating oil passage 20 and the pressing force of the inside spool 53 of the first pressure control valve 50. Thereby, the second pressure control valve 60 can quickly cause the lower portion-communicating oil passage 20 to communicate with the second oil passage 13, which consequently effectively prevents the occurrence of cavitation.

Similarly, in a case where the pressure in the second oil passage 13 increases, the abutting portion 53d of the second pressure control valve 60 presses the abutting portion 53d of the first pressure control valve 50 from the left side, which enables the first pressure control valve 50 to quickly cause the lower portion-communicating oil passage 20 to communicate with the first oil passage 12.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A hydraulic circuit comprising:
a first oil passage communicating with a first port of an actuator;
a second oil passage communicating with a second port of the actuator;
at least one oil-discharging passage communicating with an oil tank;
a first valve arranged between the first oil passage and the oil-discharging passage; and
a second valve arranged in a vicinity of the first valve and between the second oil passage and the discharge passage,
wherein the first and second valves have the following modes of operation:
a mode wherein, when a pressure of the second oil passage drops to a predetermined value or lower, the second valve allows hydraulic oil to flow into the oil-discharging passage from the second oil passage, whereby the second oil passage and the oil-discharging passage are in fluid communication with one another, and
a mode wherein, when a pressure of the first oil passage reaches a predetermined value or higher, the first valve allows hydraulic oil to flow into the oil-discharging passage from the from the first oil passage, whereby the first oil passage and the oil-discharging passage are in fluid communication with one another.

2. The hydraulic circuit according to claim 1, wherein a distance between the first valve and the second valve is less than a distance between the first oil passage and the second oil passage.

3. The hydraulic circuit according to claim 1, wherein:
the first valve comprises:
a first communicating portion communicating with the first oil passage and the oil-discharging passage; and
a slidable first spool configured to open and close the first communicating portion; and
the second valve comprises:
a second communicating portion communicating with the second oil passage and the oil-discharging passage; and
a slidable second spool configured to open and close the second communicating portion.

4. The hydraulic circuit according to claim 3, wherein the first and second spools are movable on a same axis.

5. The hydraulic circuit according to claim 1, wherein the first and second valves at least one of:
are oriented along a same axis; and
respectively comprise first and second pressure control valves.

6. The hydraulic circuit according to claim 1, wherein the first and second valves are oriented opposite one another.

7. The hydraulic circuit according to claim 1, wherein the first and second valves have the following additional modes of operation:
a mode wherein, when a pressure of the second oil passage reaches a predetermined value or higher, the second valve allows hydraulic oil to flow in the oil-discharging passage from the second oil passage, whereby the second oil passage and the oil-discharging passage are in fluid communication with one another, and
a mode wherein, when a pressure of the first oil passage drops to a predetermined value or lower, the first valve allows hydraulic oil to flow into the oil-discharging passage from the from the first oil passage, whereby the first oil passage and the oil-discharging passage are in fluid communication with one another.

8. A hydraulic circuit arranged in a housing, said housing comprising:
a first oil passage adapted to communicate with a first port of an actuator;
a second oil passage adapted to communicate with a second port of the actuator;
at least one oil-discharging passage adapted to communicate with an oil tank;
a first valve arranged between the first oil passage and the oil-discharging passage; and
a second valve arranged in a vicinity of the first valve and between the second oil passage and the discharge passage,
wherein the first and second valves have the following modes of operation:
a mode wherein, when a pressure of the second oil passage drops to a predetermined value or lower, the second valve allows hydraulic oil to flow into the oil-discharging passage from the second oil passage, whereby the second oil passage and the oil-discharging passage are in fluid communication with one another, and
a mode wherein, when a pressure of the first oil passage reaches a predetermined value or higher, the first valve allows hydraulic oil to flow into the oil-discharging passage from the from the first oil passage, whereby the first oil passage and the oil-discharging passage are in fluid communication with one another.

9. The housing of claim 8, wherein the first valve comprises an outer valve portion and an inner valve portion and the outer valve portion opens under less pressure than the inner valve portion.

10. The housing of claim 8, wherein the first valve comprises an outer valve portion and an inner valve portion and the outer valve portion opens along one direction and the inner valve portion opens along an opposite direction.

11. The housing of claim 8, wherein the second valve comprises an outer valve portion and an inner valve portion and the outer valve portion opens under less pressure than the inner valve portion.

12. The housing of claim 8, wherein the second valve comprises an outer valve portion and an inner valve portion and the outer valve portion opens along one direction and the inner valve portion opens along an opposite direction.

13. A work vehicle hydraulic circuit housing comprising:
a first oil passage adapted to communicate with a first port of an actuator;
a second oil passage adapted to communicate with a second port of the actuator;
at least one oil-discharging passage adapted to communicate with an oil tank;
a first valve arranged between the first oil passage and the oil-discharging passage; and
a second valve arranged in a vicinity of the first valve and between the second oil passage and the discharge passage,
wherein the first and second valves have the following modes of operation:
a mode wherein, when a pressure of the first oil passage increases to a predetermined value or higher, the first valve allows hydraulic oil to flow into the oil-discharging passage from the first oil passage and causes opening of the second valve, whereby the first oil passage, the oil-discharging passage and the second oil passage are in fluid communication with one another, and
a mode wherein, when a pressure of the second oil passage reaches a predetermined value or higher, the second valve allows hydraulic oil to flow into the oil-discharging passage from the from the first oil passage and causes opening of the first valve, whereby the second oil passage, the oil-discharging passage and the first oil passage are in fluid communication with one another.

14. The housing of claim 13, wherein the housing and an actuator is mounted to a work vehicle.

15. The housing of claim 14, wherein the first valve comprises an outer valve portion and an inner valve portion and the outer valve portion opens under less pressure than the inner valve portion.

16. The housing of claim 14, wherein the first valve comprises an outer valve portion and an inner valve portion and the outer valve portion opens along one direction and the inner valve portion opens along an opposite direction.

17. The housing of claim 14, wherein the second valve comprises an outer valve portion and an inner valve portion and the outer valve portion opens under less pressure than the inner valve portion.

18. The housing of claim 14, wherein the second valve comprises an outer valve portion and an inner valve portion and the outer valve portion opens along one direction and the inner valve portion opens along an opposite direction.
